(19) United States
(12) Patent Application Publication
(10) Pub. No.: US 2023/0223182 A1
(43) Pub. Date: Jul. 13, 2023

(54) COIL COMPONENT

(71) Applicant: SAMSUNG ELECTRO-MECHANICS CO., LTD., Suwon-si (KR)

(72) Inventors: Mi Geum KIM, Suwon-si (KR); Jae Hun KIM, Suwon-si (KR)

(73) Assignee: SAMSUNG ELECTRO-MECHANICS CO., LTD., Suwon-si (KR)

(21) Appl. No.: 17/991,179

(22) Filed: Nov. 21, 2022

(30) Foreign Application Priority Data
Jan. 12, 2022 (KR) 10-2022-0004549

(51) Int. Cl. H01F 27/29; H01F 27/28

(52) U.S. Cl. CPC H01F 27/29; H01F 27/2804; H01F 2027/2809

(57) ABSTRACT

A coil component includes: a body having first and second surfaces opposing each other in a first direction, and third and fourth surfaces connecting the first and second surfaces to each other and opposing each other in a second direction; a substrate disposed in the body; a coil unit disposed on the substrate, and including a coil pattern, lead-out portions connected to the coil pattern and contacting the first surface of the body while being spaced apart from the third and fourth surfaces of the body, respectively, and sub lead-out portions spaced apart from the coil pattern; and external electrodes disposed on the first surface of the body and connected to the lead-out portions, respectively, wherein each of the sub lead-out portions occupies a smaller volume within the body than each of the lead-out portions.

### CROSS-REFERENCE TO RELATED APPLICATION(S)

This application claims the benefit of priority to Korean Patent Application No. 10-2022-0004549 filed on Jan. 12, 2022 in the Korean Intellectual Property Office, the disclosure of which is incorporated herein by reference in its entirety.

### TECHNICAL FIELD

The present disclosure relates to a coil component.

### BACKGROUND

An inductor, one of coil components, is a typical passive electronic component used in an electronic device together with a resistor and a capacitor.

As electronic devices are increasingly improved in performance while their sizes become smaller, the number of electronic components used in the electronic devices has increased, and the sizes of the electronic components have decreased.

In order to realize a coil component having high-capacity and high-efficiency characteristics even in a small size, it has been demanded to increase an effective volume of the coil component with a coil unit having a vertical structure and electrodes disposed on a lower surface thereof.

### SUMMARY

An aspect of the present disclosure may reduce volumes of electrodes in a coil component to increase an effective volume of a body and improve inductance characteristics.

Another aspect of the present disclosure may provide a coil component, advantageous in terms of size reduction and integration, by forming external electrodes on a mounting surface.

According to an aspect of the present disclosure, a coil component may include: a body having first and second surfaces opposing each other in a first direction, and third and fourth surfaces connecting the first and second surfaces to each other and opposing each other in a second direction; a substrate disposed in the body; a coil unit disposed on the substrate, and including a coil pattern, lead-out portions connected to the coil pattern and contacting the first surface of the body while being spaced apart from the third and fourth surfaces of the body, respectively, and sub lead-out portions spaced apart from the coil pattern; and external electrodes disposed on the first surface of the body and connected to the lead-out portions, respectively. Each of the sub lead-out portions occupies a smaller volume within the body than each of the lead-out portions.

According to another aspect of the present disclosure, a coil component may include: a body having first and second surfaces opposing each other in a first direction, and third and fourth surfaces connecting the first and second surfaces to each other and opposing each other in a second direction; a substrate disposed in the body; a coil unit disposed on the substrate, and including a coil pattern, lead-out portions connected to the coil pattern and extending to the first surface of the body, and sub lead-out portions spaced apart from the coil pattern, the lead-out portions and the sub lead-out portions opposing each other, respectively, with respect to the substrate; and external electrodes disposed on the first surface of the body and connected to the lead-out portions, respectively. A maximum size of each of the lead-out portions in the second direction is greater than a maximum size of each of the sub lead-out portions in the second direction.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic perspective view illustrating a coil component according to a first exemplary embodiment in the present disclosure;

FIG. 2 is a bottom perspective view of FIG. 1;

FIG. 3 is a schematic view of FIG. 1 when viewed in direction A;

FIG. 4 is a perspective view of E1 of FIG. 3;

FIG. 5 is a perspective view of E2 of FIG. 3;

FIG. 6 is a schematic bottom view of FIG. 1 when viewed in direction B;

FIG. 7 is a cross-sectional view of FIG. 1 taken along line I-I′;

FIG. 8 is a modification of FIG. 4;

FIG. 9 is a modification of FIG. 5;

FIG. 10 is a schematic view illustrating a coil component according to a second exemplary embodiment in the present disclosure, corresponding to FIG. 3; and

FIG. 11 is a schematic view illustrating a coil component according to a third exemplary embodiment in the present disclosure, corresponding to FIG. 3.

### DETAILED DESCRIPTION

Hereinafter, exemplary embodiments in the present disclosure will now be described in detail with reference to the accompanying drawings.

In the drawings, a T direction may be defined as a first direction or a thickness direction, an L direction may be defined as a second direction or a length direction, and a W direction may be defined as a third direction or a width direction.

Various kinds of electronic components may be used in electronic devices, and various kinds of coil components may be appropriately used between these electronic components to remove noise or for other purposes.

That is, in the electronic devices, the coil components may be used as power inductors, high frequency (HF) inductors, general beads, high frequency (GHz) beads, common mode filters, and the like.

### (First Exemplary Embodiment)

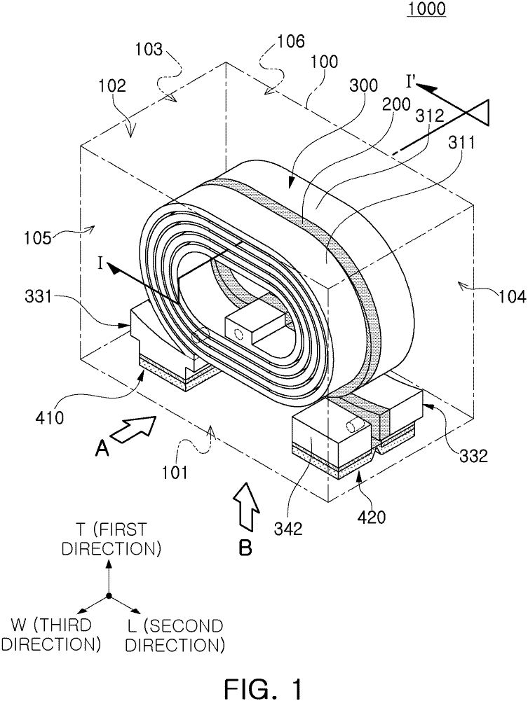

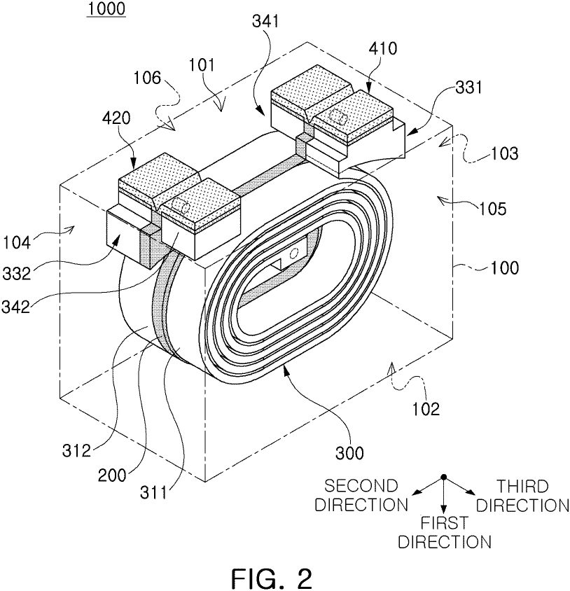

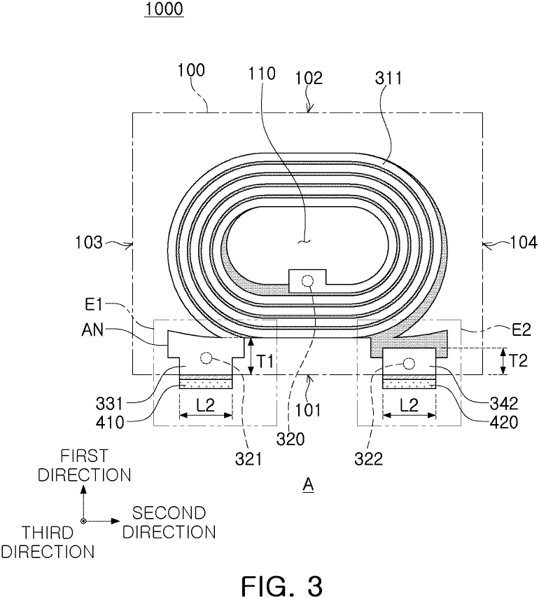

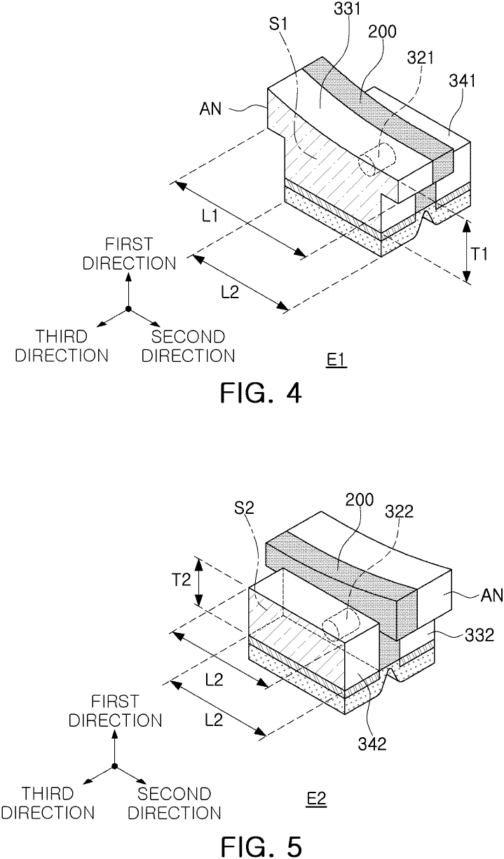

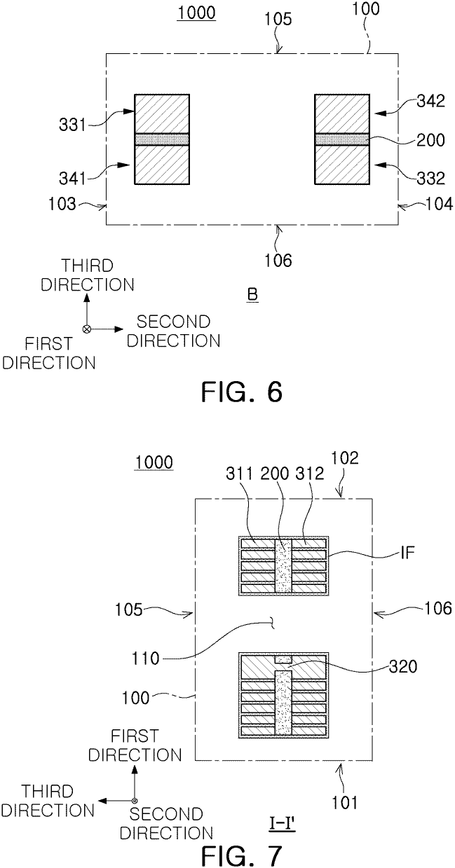

FIG. 1 is a schematic perspective view illustrating a coil component 1000 according to a first exemplary embodiment0 in the present disclosure. FIG. 2 is a bottom perspective view of FIG. 1. FIG. 3 is a schematic view of FIG. 1 when viewed in direction A. FIG. 4 is a perspective view of E1 of FIG. 3. FIG. 5 is a perspective view of E2 of FIG. 3. FIG. 6 is a schematic bottom view of FIG. 1 when viewed in direction B. FIG. 7 is a cross-sectional view of FIG. 1 taken along line I-I′.

Referring to FIGS. 1 through 7, the coil component 1000 according to the first exemplary embodiment in the present disclosure may include a body 100, a substrate 200, a coil unit 300, and external electrodes 410 and 420, and may further include an insulating film IF.

The body 100 may form an appearance of the coil component 1000 according to the present exemplary embodiment, and the substrate 200 and the coil unit 300 may be embedded in the body 100.

The body 100 may form an appearance of the coil component 1000 according to the present exemplary embodiment, and the substrate 200 and the coil unit 300 may be embedded in the body 100.

The body 100 may form an appearance of the coil component 1000 according to the present exemplary embodiment, and the coil unit 300 may be embedded in the body 100.

The body 100 may generally have a hexahedral shape.

The body 100 may have a first surface 101 and a second surface 102 opposing each other in the thickness direction T, i.e., the first direction, a third surface 103 and a fourth surface 104 opposing each other in the length direction L, i.e., the second direction, and a fifth surface 105 and a sixth surface 106 opposing each other in the width direction W, i.e., the third direction. The first to fourth surfaces 101 to 104 of the body 100 may be wall surfaces of the body 100 that connect the fifth surface 105 and the sixth surface 106 of the body 100 to each other. The third to sixth surfaces 103 to 106 of the body 100 may be wall surfaces of the body 100 that connect the first surface 101 and the second surface 102 of the body 100 to each other.

The body 100 may be formed so that the coil component 1000 according to the present exemplary embodiment in which the external electrodes 410 and 420 to be described below are formed, for example, has a length of 2.5 mm, a width of 2.0 mm, and a thickness of 1.0 mm, has a length of 2.0 mm, a width of 1.2 mm, and a thickness of 0.65 mm, has a length of 1.6 mm, a width of 0.8 mm, and a thickness of 0.8 mm, has a length of 1.0 mm, a width of 0.5 mm, and a thickness of 0.8 mm, or has a length of 0.8 mm, a width of 0.4 mm, and a thickness of 0.65 mm, but is not limited thereto. Meanwhile, the above-described exemplary numerical values for the length, width, and thickness of the coil component 1000 refer to numerical values in which process errors are not reflected. Thus, numerical values including process errors in an allowable range may be considered to fall within the above-described exemplary numerical values.

Based on an image of a cross section of the coil component 1000 in the length direction L-thickness direction T taken at a central portion thereof in the width direction W using an optical microscope or a scanning electron microscope (SEM), the above-mentioned length of the coil component 1000 may refer to a maximum value among dimensions of a plurality of line segments spaced apart from each other in the thickness direction T, each connecting two outermost boundary lines opposing each other in the length direction L of the coil component 1000 in parallel to the length direction L in the image. Alternatively, the length of the coil component 1000 may refer to a minimum value among the dimensions of the plurality of line segments described above. Alternatively, the length of the coil component 1000 may refer to an arithmetic mean value of at least three among the dimensions of the plurality of line segments described above. Here, the plurality of line segments parallel to the length direction L may be equally spaced from each other in the thickness direction T, but the scope of the present disclosure is not limited thereto. Other measurement methods and/or tools appreciated by one of ordinary skill in the art, even if not described in the present disclosure, may also be used.

Based on an image of a cross section of the coil component 1000 in the length direction L-thickness direction T taken at a central portion thereof in the width direction W using an optical microscope or a scanning electron microscope (SEM) , the above-mentioned thickness of the coil component 1000 may refer to a maximum value among dimensions of a plurality of line segments spaced apart from each other in the length direction L, each connecting two outermost boundary lines opposing each other in the thickness direction T of the coil component 1000 in parallel to the thickness direction T in the image. Alternatively, the thickness of the coil component 1000 may refer to a minimum value among the dimensions of the plurality of line segments described above. Alternatively, the thickness of the coil component 1000 may refer to an arithmetic mean value of at least three among the dimensions of the plurality of line segments described above. Here, the plurality of line segments parallel to the thickness direction T may be equally spaced from each other in the length direction L, but the scope of the present disclosure is not limited thereto.

Based on an image of a cross section of the coil component 1000 in the length direction L-width direction W taken at a central portion thereof in the thickness direction T using an optical microscope or a scanning electron microscope (SEM), the above-mentioned width of the coil component 1000 may refer to a maximum value among dimensions of a plurality of line segments spaced apart from each other in the length direction L, each connecting two outermost boundary lines opposing each other in the width direction W of the coil component 1000 in parallel to the width direction W in the image. Alternatively, the width of the coil component 1000 may refer to a minimum value among the dimensions of the plurality of line segments described above. Alternatively, the width of the coil component 1000 may refer to an arithmetic mean value of at least three among the dimensions of the plurality of line segments described above. Here, the plurality of line segments parallel to the width direction W may be equally spaced from each other in the length direction L, but the scope of the present disclosure is not limited thereto. Other measurement methods and/or tools appreciated by one of ordinary skill in the art, even if not described in the present disclosure, may also be used.

Alternatively, each of the length, width, and thickness of the coil component 1000 may be measured by a micrometer measurement method. In the micrometer measurement method, each of the length, width, and thickness of the coil component 1000 may be measured by setting a zero point using a micrometer having gage repeatability and reproducibility (R&R) , inserting the coil component 1000 according to the present exemplary embodiment between tips of the micrometer, and turning a measurement lever of the micrometer. Meanwhile, concerning the measurement of the length of the coil component 1000 by the micrometer measurement method, the length of the coil component 1000 may refer to a value measured once, or may refer to an arithmetic mean of values measured multiple times. The same may also be applied to the width and the thickness of the coil component 1000.

The body 100 may include a magnetic material and a resin. Specifically, the body 100 may be formed by stacking one or more magnetic composite sheets in which the magnetic material is dispersed in the resin. However, the body 100 may also have a structure other than the structure in which the magnetic material is dispersed in the resin. For example, the body 100 may be made of a magnetic material such as ferrite, or may be made of a non-magnetic material.

The magnetic material may be ferrite or metal magnetic powder.

The ferrite may be, for example, one or more of spinel type ferrite such as Mg—Zn—based ferrite, Mn—Zn—based ferrite, Mn—Mg—based ferrite, Cu—Zn—based ferrite, Mg—Mn—Sr—based ferrite, or Ni—Zn—based ferrite, hexagonal ferrite such as Ba—Zn—based ferrite, Ba—Mg—based ferrite, Ba—Ni—based ferrite, Ba—Co—based ferrite, or Ba—Ni—Co—based ferrite, garnet type ferrite such as Y-based ferrite, and Li-based ferrite.

The metal magnetic powder may include one or more selected from the group consisting of iron (Fe), silicon (Si) , chromium (Cr), cobalt (Co), molybdenum (Mo), aluminum (Al), niobium (Nb), copper (Cu), and nickel (Ni). For example, the metal magnetic powder may be one or more of pure iron powder, Fe—Si—based alloy powder, Fe—Si—Al—based alloy powder, Fe—Ni—based alloy powder, Fe—Ni—Mo—based alloy powder, Fe—Ni—Mo—Cu—based alloy powder, Fe—Co—based alloy powder, Fe—Ni—Co—based alloy powder, Fe—Cr—based alloy powder, Fe—Cr—Si—based alloy powder, Fe—Si—Cu—Nb—based alloy powder, Fe—Ni—Cr—based alloy powder, and Fe—Cr—Al—based alloy powder.

The metal magnetic powder may be amorphous or crystalline. For example, the metal magnetic powder may be Fe—Si—B—Cr—based amorphous alloy powder, but is not necessarily limited thereto.

Each of the ferrite and the metal magnetic powder may have an average particle diameter of about 0.1 µm to 30 µm, but is not limited thereto.

The body 100 may include two or more types of magnetic materials dispersed in the resin. Here, the different types of magnetic materials mean that the magnetic materials dispersed in the resin are distinguished from each other in terms of any one of average particle diameter, composition, crystallinity, and shape.

The resin may include an epoxy, a polyimide, a liquid crystal polymer (LCP), or a mixture thereof, but is not limited thereto.

The body 100 may include a core 110 penetrating through the substrate 200 and the coil unit 300 to be described below. The core 110 may be formed by filling a through hole of the coil unit 300 with the magnetic composite sheets, but is not limited thereto.

The substrate 200 may be disposed in the body 100. The substrate 200 may be configured to support the coil unit 300 to be described below. In the coil component 1000 according to the present exemplary embodiment, the substrate 200 may be disposed perpendicular to the first surface 101, which is a mounting surface, but is not limited thereto.

The substrate 200 may be formed of an insulating material including a thermosetting insulating resin such as an epoxy resin, a thermoplastic insulating resin such as a polyimide resin, or a photosensitive insulating resin, or may be formed of an insulating material in which a reinforcing material such as a glass fiber or an inorganic filler is impregnated in such an insulating resin. As an example, the substrate 200 may be formed of prepreg, an Ajinomoto build-up film (ABF), FR-4, a bismaleimide triazine (BT) resin, a photoimageable dielectric (PID), a copper clad laminate (CCL), or the like, but is not limited thereto.

The inorganic filler may be at least one selected from the group consisting of silica (SiO₂) , alumina (Al₂O₃), silicon carbide (SiC), barium sulfate (BaSO₄) , talc, clay, mica powder, aluminum hydroxide (Al(OH)₃), magnesium hydroxide (Mg(OH)₂), calcium carbonate (CaCO₃) , magnesium carbonate (MgCO₃), magnesium oxide (MgO), boron nitride (BN) , aluminum borate (AlBO₃), barium titanate (BaTiO₃), and calcium zirconate (CaZrO₃) .

When the substrate 200 is formed of an insulating material including a reinforcing material, the substrate 200 may provide more excellent rigidity. When the substrate 200 is formed of an insulating material including no glass fiber, a total thickness of the substrate 200 and the coil unit 300 (which refers to the sum of dimensions of the coil unit and the substrate in the width direction W of FIG. 1) may decrease, which is advantageous in decreasing a width of the coil component. When the substrate 200 is formed of an insulating material including a photosensitive insulating resin, the number of processes for forming the coil unit 300 may decrease, which is advantageous in decreasing a production cost and in forming a fine via 320. The substrate 200 may have a thickness of, for example, 10 µm or more and 50 µm or less, but is not limited thereto.

The coil unit 300 may be disposed on the substrate 200. The coil unit 300 may be embedded in the body 100 to exhibit characteristics of the coil component. For example, when the coil component 1000 according to the present exemplary embodiment is utilized as a power inductor, the coil unit 300 may serve to stabilize power of an electronic device by storing an electric field as a magnetic field and maintaining an output voltage.

In the present exemplary embodiment, since coil patterns 311 and 312 of the coil unit 300 are disposed perpendicular to the first surface 101 of the body 100, which is a mounting surface, it is possible to reduce a mounting area while maintaining volumes of the body 100 and the coil unit 300. Accordingly, a larger number of electronic components can be mounted on a mounting board having the same area. In addition, in the present exemplary embodiment, since the coil patterns 311 and 312 of the coil unit 300 are disposed perpendicular to the first surface 101 of the body 100, which is a mounting surface, a magnetic flux is induced to the core 110 by the coil unit 300 in a direction parallel to the first surface 101 of the body 100. Accordingly, noise induced to a mounting surface of the mounting board can be relatively reduced.

Meanwhile, in the present specification, the disposition of the coil patterns 311 and 312 of the coil unit 300 perpendicular to the first surface 101 of the body 100, which is a mounting surface, means that, as illustrated in FIG. 1, each of virtual planes extending from surfaces of the first and second coil patterns 311 and 312 contacting the substrate 200 form a perpendicular angle or an almost perpendicular angle with the first surface 101 of the body 100. For example, each of the first and second coil patterns 311 and 312 may form an angle of 80° to 100° with the first surface 101 of the body 100.

The coil unit 300 may be formed on at least one of opposite surfaces of the substrate 200 with at least one turn. The coil unit 300 may be disposed on one surface and the other surface of the substrate 200 opposing each other in the width direction W of the body 100, and disposed perpendicular to the first surface 101 of the body 100. In the present exemplary embodiment, the coil unit 300 may include coil patterns 311 and 312, a via 320, lead-out portions 331 and 332, sub lead-out portions 341 and 342, and sub vias 321 and 322.

The first coil pattern 311 and the second coil pattern 312 may be disposed on the opposite surfaces of the substrate 200, respectively, each having a planar spiral shape in which at least one turn is formed around the core 110 of the body 100. For example, based on the directions of FIG. 1, the first coil pattern 311 may be disposed on a front surface of the substrate 200 with at least one turn formed around the core 110. The second coil pattern 312 may be disposed on a rear surface of the substrate 200 with at least one turn formed around the core 110. The first and second coil patterns 311 and 312 may be formed in such a manner that end portions of outermost turns thereof connected to the lead-out portions 331 and 332, respective, extend from a central portion of the body 100 in the thickness direction T toward the first surface 101 of the body 100. That is, regions where the end portions of the outermost turns of the first and second coil patterns 311 and 312 are connected to the lead-out portions 331 and 332, respectively, may be disposed closer to the first surface 101 than the second surface 102 of the body 100. As a result, the first and second coil patterns 311 and 322 may increase the total number of turns of the coil unit 300 as compared with that in a case where an end portion of an outermost turn of a coil is formed only up to the central portion of the body 100 in the thickness direction T.

Referring to FIG. 7, the via 320 may penetrate through the substrate 200 to connect inner end portions of respective innermost turns of the first and second coil patterns 311 and 312 to each other.

Referring to FIGS. 1 and 2, the lead-out portions 331 and 332 and the sub lead-out portions 341 and 342 may contact the first surface 101 of the body 100 while being spaced apart from each other. In addition, the lead-out portions 331 and 332 and the sub lead-out portions 341 and 342 may be disposed to be spaced apart from the third and fourth surfaces 103 and 104 of the body 100. That is, the coil component 1000 according to the present exemplary embodiment may have a structure in which the lead-out portions 331 and 332 and the sub lead-out portions 341 and 342 are exposed only to the mounting surface, but is not limited thereto.

Specifically, based on the directions of FIG. 1, the first lead-out portion 331 may extend from the first coil pattern 311 on the front surface of the substrate 200 to be exposed to the first surface 101 of the body 100, and the first sub lead-out portion 341 may be disposed to have a shape corresponding to the first lead-out portion 331 at a position corresponding to the first lead-out portion 331 on the rear surface of the substrate 200, while being spaced apart from the second coil pattern 312.

In addition, the second lead-out portion 332 may extend from the second coil pattern 312 on the rear surface of the substrate 200 to be exposed to the first surface 101 of the body 100, and the second sub lead-out portion 342 may be disposed to have a shape corresponding to the second lead-out portion 332 at a position corresponding to the second lead-out portion 332 on the front surface of the substrate 200, while being spaced apart from the first coil pattern 311.

Referring to FIGS. 1 through 3, the lead-out portions 331 and 332, which are configured to be connected to the end portions of the outermost turns of the coil patterns 311 and 312, may be defined as being branched from winding directions of the outermost turns to be exposed the first surface 101 of the body 100. The coil patterns 311 and 312 and the lead-out portions 331 and 332 may be integrally formed by a plating process. In the present specification, however, for convenience, boundaries between the coil patterns 311 and 312 and the lead-out portions 331 and 332 are indicated by dotted lines parallel to the first surface 101 of the body 100. Thus, in the present specification, the lead-out portions 331 and 332 may be defined as including regions up to the dotted lines.

The first lead-out portion 331 and the first sub lead-out portion 341, and the second lead-out portion 332 and the second sub lead-out portion 342 may be exposed to the first surface 101 of the body 100, while being spaced apart from each other, and may be connected in contact with the first and second external electrodes 410 and 420 to be described below, respectively.

Referring to FIGS. 4 and 5, the lead-out portions 331 and 332 and the sub lead-out portions 341 and 342 may be connected to each other by the sub vias 321 and 322 penetrating through the substrate 200.

The first sub via 321 may penetrate through the substrate 200 to connect the first lead-out portion 331 and the first sub lead-out portion 341 to each other. The second sub via 322 may penetrate through the substrate 200 to connect the second lead-out portion 332 and the second sub lead-out portion 342 to each other. By doing so, the coil unit 300 may function as a single coil as a whole.

Referring to FIGS. 1 through 6, each of the sub lead-out portions 341 and 342 may be formed to have a smaller volume occupied thereby in the body 100 than each of the lead-out portions 331 and 332.

As a comparative example of the coil component 1000 according to the present exemplary embodiment, when a total volume of the coil component 1000 is 0.21228 mm³, if each of the sub lead-out portions 341 and 342 has the same shape as each of the lead-out portions 331 and 332, the volume of each of the sub lead-out portions 341 and 342 is 0.003666 mm³, and a ratio of the volume occupied by each of the sub lead-out portions 341 and 342 in the total volume of the coil component is 1.73%.

In contrast, as an example of the coil component 1000 according to the present exemplary embodiment, when a total volume of the coil component 1000 is 0.21228 mm³, if each of the sub lead-out portions 341 and 342 has a smaller volume than each of the lead-out portions 331 and 332, the volume of each of the sub lead-out portions 341 and 342 is 0.00208 mm³, and a ratio of the volume occupied by each of the sub lead-out portions 341 and 342 in the total volume of the coil component 1000 is 0.98%.

Here, an amount of the magnetic material in the body 100 may increase as much as a reduced volume of each of the sub lead-out portions 341 and 342, and accordingly, an effective volume of the coil component 1000 may increase, thereby improving inductance characteristics.

Referring to FIGS. 3 and 6, each of the sub lead-out portions 341 and 342 may have a cross section in a rectangular shape, when cut perpendicular to the first to fourth surfaces 101 to 104 of the body 100.

Referring to FIGS. 4 and 5, a cross-sectional area S2 of each of the sub lead-out portions 341 and 342 may be smaller than a cross-sectional area S1 of each of the lead-out portions 331 and 332, and a ratio S2/S1 of the cross-sectional area S2 of each of the sub lead-out portions 341 and 342 to the cross-sectional area S1 of each of the lead-out portions 331 and 332 may be more than 0.45 and less than 1.

Here, the cross-sectional area S1 of each of the lead-out portions 331 and 332 may refer to an area of a cross section of each of the lead-out portions 331 and 332 taken at a central portion thereof in the third direction in parallel to the fifth surface 105 of the body 100, and the cross-sectional area S2 of each of the sub lead-out portions 341 and 342 may refer to an area of a cross section of each of the sub lead-out portions 341 and 342 taken at a central portion thereof in the third direction in parallel to the fifth surface 105 of the body 100.

Meanwhile, as an example for measuring a cross-sectional area of each of the lead-out portions 331 and 332 and the sub lead-out portions 341 and 342, based on an image of a cross section of each of the coil patterns 311 and 312 in the length direction L-thickness direction T taken at a central portion thereof in the width direction W using an optical microscope or a scanning electron microscope (SEM), an area of each of the lead-out portions 331 and 332 and the sub lead-out portions 341 and 342 may be calculated using an Image J program tool, but the scope of the present disclosure is not limited thereto. Other measurement methods and/or tools appreciated by one of ordinary skill in the art, even if not described in the present disclosure, may also be used.

As an example of the coil component 1000 according to the present exemplary embodiment, when each of the lead-out portions 331 and 332 has a cross-sectional area S1 of 0.0141 mm², each of the sub lead-out portions 341 and 342 may have a cross-sectional area S2 of 0.0064 mm² or more. That is, the ratio S2/S1 of the cross-sectional area S2 of each of the sub lead-out portions 341 and 342 to the cross-sectional area S1 of each of the lead-out portions 331 and 332 may be more than 0.45 and less than 1.

In this range, which is determined in consideration of a size of each of the sub vias 321 and 322 connecting the lead-out portions 331 and 332 and the sub lead-out portions 341 and 342 to each other, the sub vias 321 and 322 penetrating through the substrate 200 may not be exposed to the body 100 for connection reliability between the lead-out portions 331 and 332 and the sub lead-out portions 341 and 342.

Referring to FIGS. 3 through 5, each of the lead-out portions 331 and 332 and the sub lead-out portions 341 and 342 of the coil component 1000 according to the present exemplary embodiment may have one surface exposed to the first surface 101 of the body 100, and the other surface opposing the one surface.

Here, one surface of each of the lead-out portions 331 and 332 may refer to a surface exposed to the first surface 101 of the body 100 and contacting each of the external electrodes 410 and 420 to be described below, and the other surface of each of the lead-out portions 331 and 332 may refer to a surface opposing the one surface of each of the lead-out portions 331 and 332 and including a region contacting the body 100 and a region connected to the end portion of the outermost turn of each of the coil patterns 311 and 312. Referring to FIG. 4, the other surface of each of the lead-out portions 331 and 332 may include a curved surface.

Also, one surface of each of the sub lead-out portions 341 and 342 may refer to a surface exposed to the first surface 101 of the body 100 and contacting each of the external electrodes 410 and 420 to be described below, and the other surface of each of the sub lead-out portions 341 and 342 may refer to a surface opposing the one surface of each of the sub lead-out portions 341 and 342 and contacting the body 100.

Referring to FIGS. 3 through 5, a maximum size T2 in the first direction from the first surface 101 of the body 100 to the other surface of each of the sub lead-out portions 341 and 342 may be smaller than a minimum size T1 in the first direction from the first surface 101 of the body 100 to the other surface of each of the lead-out portions 331 and 332.

Meanwhile, as an example for measuring a minimum size T1 in the first direction from the first surface 101 of the body 100 to the other surface of each of the lead-out portions 331 and 332, based on an image of a cross section of each of the coil patterns 311 and 312 in the length direction L-thickness direction T taken at a central portion thereof in the width direction W using an optical microscope or a scanning electron microscope (SEM), a minimum value may be selected among dimensions of a plurality of line segments spaced apart from each other in the length direction L, each connecting two outermost boundary lines opposing each other in the thickness direction T of each of the lead-out portions 331 and 332 in parallel to the thickness direction T in the image. Other measurement methods and/or tools appreciated by one of ordinary skill in the art, even if not described in the present disclosure, may also be used.

Also, as an example for measuring a maximum size T2 in the first direction to the other surface of each of the sub lead-out portions 341 and 342, a maximum value may be selected among the dimensions of the plurality of line segments spaced apart from each other in the length direction L, each connecting two outermost boundary lines opposing each other in the thickness direction T of each of the sub lead-out portions 341 and 342 in parallel to the thickness direction T in the image.

Here, the plurality of line segments parallel to the thickness direction T may be equally spaced from each other in the length direction L, but the scope of the present disclosure is not limited thereto.

A ratio T2/T1 of the maximum size T2 in the first direction from the first surface 101 of the body 100 to the other surface of each of the sub lead-out portions 341 and 342 to the minimum size T1 in the first direction from the first surface 101 of the body 100 to the other surface of each of the lead-out portions 331 and 332 may be more than 0.5 and less than 1.

In this range, which is determined in consideration of a size of each of the sub vias 321 and 322 connecting the lead-out portions 331 and 332 and the sub lead-out portions 341 and 342 to each other, the sub vias 321 and 322 penetrating through the substrate 200 may not be exposed to the body 100 for connection reliability between the lead-out portions 331 and 332 and the sub lead-out portions 341 and 342.

Referring to FIGS. 1, 4, and 5, since the other surface of each of the lead-out portions 331 and 332 includes a curved surface, each of the lead-out portions 331 and 332 may have a cross-sectional area that decreases inward of the body 100 from the surface of the body 100, based on a cross section thereof perpendicular to the second direction. Meanwhile, each of the sub lead-out portions 341 and 342 may have a cross-sectional area that is substantially constant in the second direction, based on a cross section thereof perpendicular to the second direction.

Referring to FIG. 6, the cross-sectional area of each of the lead-out portions 331 and 332 exposed to the first surface 101 of the body 100 may be substantially the same as the cross-sectional area of each of the sub lead-out portions 341 and 342 exposed to the first surface 101 of the body 100. By doing so, it is possible to secure connection reliability between the external electrodes 410 and 420 to be described below and the coil unit 300, and it is also possible to form the external electrodes 410 and 420 symmetrically, thereby preventing warpage of the substrate 200.

Each of the first and second lead-out portions 331 and 332 may include an anchor portion AN protruding toward the body 100. That is, the first lead-out portion 331 may include an anchor portion AN further protruding toward the third surface 103 of the body 100 than the other region of the first lead-out portion 331. Also, the second lead-out portion 332 may include an anchor portion AN further protruding toward the fourth surface 104 of the body 100 than the other region of the second lead-out portion 332.

In addition, referring to FIG. 3, the anchor portions AN of the coil component 1000 according to the present exemplary embodiment may also protrude in a direction from the first surface 101 toward the second surface 102 of the body 100, and thus, the anchor portions AN may be disposed closer to the second surface 102 of the body 100 than the regions other than the anchor portions AN of the first and second lead-out portions 331 and 332.

The structure in which each of the first and second lead-out portions 331 and 332 includes an anchor portion AN as described above makes it possible to increase a resistance to an external force generated in the thickness direction T of the body 100, i.e., the first direction (anchoring effect).

When the coil unit 300 includes both lead-out portions 331 and 332 and sub lead-out portions 341 and 342 as in the present exemplary embodiment, it is possible to symmetrically form the external electrodes 410 and 420 on the first surface 101 of the body 100, thereby preventing warpage of the substrate 200 and suppressing an appearance defect of the coil component 1000 accordingly.

Meanwhile, the sub lead-out portions 341 and 342 are irrelevant to electrical connection relationship between the coil unit 300 and the external electrodes 410 and 420 to be described below. Thus, even in a case where the first and second sub vias 321 and 322 are omitted, this case also falls within the scope of the present disclosure.

However, when the lead-out portions 331 and 332 and the sub lead-out portions 341 and 342 are connected to each other by the first and second sub vias 321 and 322, respectively, as in the present exemplary embodiment, it is possible to improve connection reliability between the coil unit 300 and the external electrodes 410 and 420, and it is also possible to electrically connect the sub lead-out portions 341 and 342 to the external electrodes 410 and 420 and the coil patterns 311 and 312, thereby securing an electrode surface and improving Rdc characteristics accordingly.

At least one of the coil patterns 311 and 312, the via 320, the lead-out portions 331 and 332, the sub lead-out portions 341 and 342, and the sub vias 321 and 322 may include at least one conductive layer.

For example, when the first coil pattern 311, the via 320, the first lead-out portion 331, the second sub lead-out portion 342, and the sub vias 321 and 322 are plated on the front surface of the substrate 200 (based on the directions of FIG. 1), each of the first coil pattern 311, the via 320, the first lead-out portion 331, the second sub lead-out portion 342, and the sub vias 321 and 322 may include a seed layer and an electrolytic plating layer. The seed layer may be formed by an electroless plating method or a vapor deposition method such as sputtering. Each of the seed layer and the electrolytic plating layer may have a single-layer structure or have a multi-layer structure. The electrolytic plating layer having the multi-layer structure may be formed in a conformal film structure in which one electrolytic plating layer covers another electrolytic plating layer, or may be formed by stacking one electrolytic plating layer on only one surface of another electrolytic plating layer. The seed layer of the first coil pattern 311, the seed layer of the via 320, the seed layer of the first lead-out portion 331, and the seed layer of the first sub via 321 may be integrally formed, such that no boundaries are formed therebetween, but are not limited thereto. The electrolytic plating layer of the first coil pattern 311, the electrolytic plating layer of the via 320, the electrolytic plating layer of the first lead-out portion 331, and the electrolytic plating layer of the first sub via 321 may be integrally formed, such that no boundaries are formed therebetween, but are not limited thereto.

Each of the coil patterns 311 and 312, the via 320, the lead-out portions 331 and 332, the sub lead-out portions 341 and 342, and the sub vias 321 and 322 may include a conductive material such as copper (Cu), aluminum (Al), silver (Ag), tin (Sn), gold (Au) , nickel (Ni) , lead (Pb) , titanium (Ti) , chromium (Cr), molybdenum (Mo), or an alloy thereof, but is not limited thereto.

The external electrodes 410 and 420 may be disposed to be spaced apart from each other on the first surface 101 of the body 100 to be connected to the lead-out portions 331 and 332 and the sub lead-out portions 341 and 342, respectively. Specifically, the first external electrode 410 may be disposed on the first surface 101 of the body 100 to be connected in contact with the first lead-out portion 331 and the first sub lead-out portion 341. Also, the second external electrode 420 may be disposed to be spaced apart from the first external electrode 410 on the first surface 101 of the body 100 to be connected in contact with the second lead-out portion 332 and the second sub lead-out portion 342.

Meanwhile, the substrate 200 may be disposed, for example, between the first lead-out portion 331 and the first sub lead-out portion 341 and exposed to the first surface 101 of the body 100. In this case, the first external electrode 410 may have a recess formed in a region corresponding to the substrate 200 exposed to the first surface 101 of the body 100 due to plating deviation, but is not limited thereto.

When the coil component 1000 according to the present exemplary embodiment is mounted on a printed circuit board or the like, the external electrodes 410 and 420 may electrically connect the coil component 1000 to the printed circuit board or the like. For example, the coil component 1000 according to the present exemplary embodiment may be mounted on the printed circuit board so that the first surface 101 of the body 100 faces an upper surface of the printed circuit board to electrically connect the external electrodes 410 and 420, which are disposed to be spaced apart from each other on the first surface 101 of the body 100, to connectors of the printed circuit board.

The external electrodes 410 and 420 may be formed of a conductive material such as copper (Cu) , aluminum (Al), silver (Ag) , tin (Sn), gold (Au), nickel (Ni), lead (Pb), chromium (Cr), titanium (Ti), or an alloy thereof, but are not limited thereto.

Each of the external electrodes 410 and 420 may be formed in a plurality of layers. For example, the first external electrode 410 may include a first layer contacting the first lead-out portion 331 and the first sub lead-out portion 341, and a second layer disposed on the first layer. Here, the first layer may be a conductive resin layer including a conductive powder including at least one of copper (Cu) and silver (Ag) and an insulating resin, or a copper (Cu) plating layer. The second layer may have a double-layer structure of a nickel (Ni) plating layer and a tin (Sn) plating layer.

The insulating film IF may be disposed between the coil unit 300 and the body 100 to cover the coil unit 300. The insulating film IF may be formed along the surfaces of the substrate 200 and the coil unit 300. The insulating film IF may be provided to insulate the coil unit 300 from the body 100, and may include a known insulating material such as parylene, but is not limited thereto. The insulating film IF may be formed by a vapor deposition method or the like, but is not limited thereto. Alternatively, the insulating film IF may be formed by stacking insulation films on both surfaces of the substrate 200.

Meanwhile, although not illustrated, the coil component 1000 according to the present exemplary embodiment may further include a surface insulating layer covering the first to sixth surfaces 101 to 106 of the body 100 but exposing the external electrodes 410 and 420. The surface insulating layer may be formed by, for example, applying an insulating material including an insulating resin onto the surfaces of the body 100, and then curing the insulating material. In this case, the surface insulating layer may include at least one of a thermoplastic resin such as polystyrene, vinyl acetate, polyester, polyethylene, polypropylene, polyamide, rubber, or acryl, a thermosetting resin such as phenol, epoxy, urethane, melamine, or alkyd, and a photosensitive insulating resin.

### (Modification of First Exemplary Embodiment)

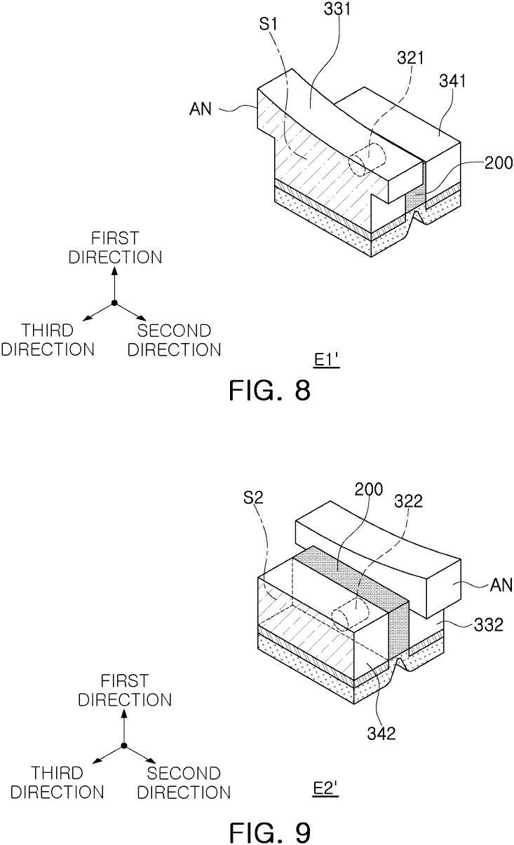

FIG. 8 is a modification of FIG. 4. FIG. 9 is a modification of FIG. 5.

Upon comparing FIGS. 8 and 9 with FIGS. 4 and 5, respectively, they are different in terms of the shape of the substrate 200 disposed between the lead-out portions 331 and 332 and the sub lead-out portions 341 and 342. Thus, in describing the present modification, only the shape of the substrate 200 disposed between the lead-out portions 331 and 332 and the sub lead-out portions 341 and 342, which is different from that of the first exemplary embodiment in the present disclosure, will be described. Concerning the other configurations of the present modification, what has been described above for the first exemplary embodiment in the present disclosure may be identically applied thereto.

Referring to FIGS. 8 and 9, in the present modification, the substrate 200 disposed between the lead-out portions 331 and 332 and the sub lead-out portions 341 and 342 may be formed to have a shape corresponding to the sub lead-out portions 341 and 342, rather than the lead-out portions 331 and 332. Specifically, the substrate 200 contacting the first lead-out portion 331 may be formed according to a shape of the first sub lead-out portion 341, and the substrate 200 contacting the second lead-out portion 332 may be formed according to a shape of the second sub lead-out portion 342.

After a plating process for forming the lead-out portions 331 and 332 and the sub lead-out portions 341 and 342, the above-described structure may be formed by removing a region other than the shapes of the sub lead-out portions 341 and 342 from the substrate 200 using CO₂ laser or the like, but is not limited thereto.

According to the present modification, the magnetic material may be further filled in the body 100 as much as a reduced volume of the substrate 200 as compared with the volume of the substrate 200 in the first exemplary embodiment, thereby increasing an effective volume and improving inductance characteristics accordingly.

### (Second and Third Exemplary Embodiments)

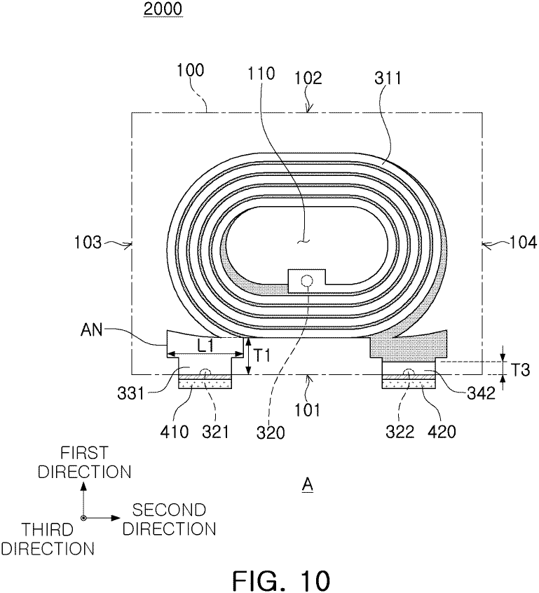

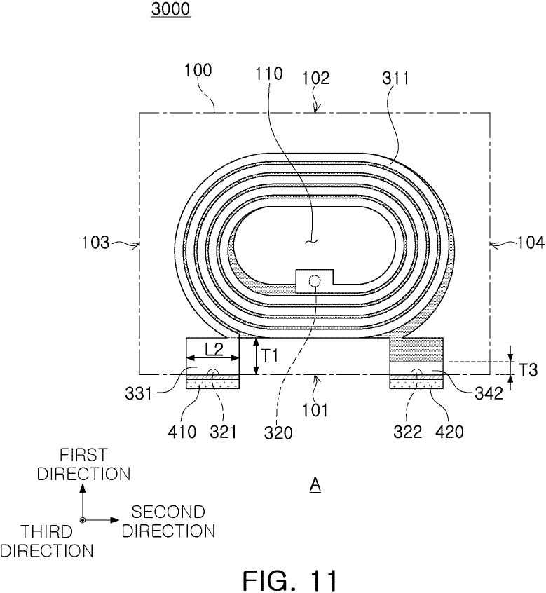

FIG. 10 is a schematic view illustrating a coil component 2000 according to a second exemplary embodiment in the present disclosure, corresponding to FIG. 3. FIG. 11 is a schematic view illustrating a coil component 3000 according to a third exemplary embodiment in the present disclosure, corresponding to FIG. 3.

Upon comparing FIG. 10 with FIG. 3, the coil component 2000 according to the second exemplary embodiment in the present disclosure is different from the coil component 1000 according to the first exemplary embodiment in the present disclosure in the shapes and sizes of the sub lead-out portions 341 and 342 and the sub vias 321 and 322. Thus, in describing the present exemplary embodiment, only the sub lead-out portions 341 and 342 and the sub vias 321 and 322, which are different from those of the first exemplary embodiment in the present disclosure, will be described. Concerning the other configurations of the present exemplary embodiment, what has been described above for the first exemplary embodiment in the present disclosure may be identically applied thereto.

Referring to FIG. 10, in the coil component 2000 according to the second exemplary embodiment in the present disclosure, the first and second sub vias 321 and 322 penetrating through the substrate 200 to connect the first and second lead-out portions 331 and 332 and the first and second sub lead-out portions 341 and 342, respectively, may be exposed to the first surface 101 of the body 100.

In this case, one surfaces of the sub vias 321 and 322 may contact the external electrodes 410 and 420, and may be coplanar with the first surface 101 of the body 100. In addition, each of the sub vias 321 and 322 may have a semicircular shape.

Each of the sub lead-out portions 341 and 342 may be formed to have a thickness, i.e., a size T3 in the first direction, smaller than the size T2 in the first direction of each of the sub lead-out portions 341 and 342 in the first exemplary embodiment as much as an area secured by forming each of the sub vias 321 and 322 in the semicircular shape. Therefore, the decrease in volume of the sub lead-out portions 341 and 342 may further increase an effective volume increasing effect.

Upon comparing FIG. 11 with FIG. 10, the coil component 3000 according to the third exemplary embodiment in the present disclosure is different from the coil component 2000 according to the second exemplary embodiment in the present disclosure in the shape of each of the lead-out portions 331 and 332 and whether each of the lead-out portions 331 and 332 includes an anchor portion AN. Thus, in describing the present exemplary embodiment, only the lead-out portions 331 and 332 and the anchor portion AN, which are different from those of the second exemplary embodiment in the present disclosure, will be described. Concerning the other configurations of the present exemplary embodiment, what has been described above for the second exemplary embodiment in the present disclosure may be identically applied thereto.

Referring to FIG. 11, in the coil component 3000 according to the third exemplary embodiment in the present disclosure, the anchor portion AN may be omitted from each of the lead-out portions 331 and 332, and also, the portions protruding toward the third and fourth surfaces 103 and 104 of the body 100 may be omitted from each of the lead-out portions 331 and 332.

In this case, each of the lead-out portions 331 and 332 may be formed to have a length, i.e., a maximum size L2 in the second direction, smaller than a maximum size L1 in the second direction of each of the lead-out portions 331 and 332 in the second exemplary embodiment. Also, each of the lead-out portions 331 and 332 may have substantially the same length as each of the sub lead-out portions 341 and 342.

Accordingly, an effective volume of the coil component 3000 may increase as much as a reduced volume of each of the lead-out portions 331 and 332, thereby further improving inductance characteristics.

As set forth above, according to an aspect of the present disclosure, by reducing the volumes of the electrodes in the coil component, an effective volume of the body can be increased, and accordingly, inductance characteristics can be improved.

According to another aspect of the present disclosure, by forming the external electrodes on the mounting surface, it is possible to provide a coil component, advantageous in terms of size reduction and integration.

While exemplary embodiments have been shown and described above, it will be apparent to those skilled in the art that modifications and variations could be made without departing from the scope of the present invention as defined by the appended claims.

What is claimed is:

1. A coil component comprising:
a body having first and second surfaces opposing each other in a first direction, and third and fourth surfaces connecting the first and second surfaces to each other and opposing each other in a second direction;
a substrate disposed in the body;
a coil unit disposed on the substrate, and including a coil pattern, lead-out portions connected to the coil pattern and contacting the first surface of the body while being spaced apart from the third and fourth surfaces of the body, respectively, and sub lead-out portions spaced apart from the coil pattern; and
external electrodes disposed on the first surface of the body and connected to the lead-out portions, respectively,
wherein each of the sub lead-out portions occupies a smaller volume within the body than each of the lead-out portions.

2. The coil component of claim 1, wherein each of the sub lead-out portions has a cross section in a rectangular shape, in a cut view perpendicular to the first to fourth surfaces of the body.

3. The coil component of claim 2, wherein a ratio of a cross-sectional area of each of the sub lead-out portions to a cross-sectional area of each of the lead-out portions is more than 0.45 and less than 1.

4. The coil component of claim 3, wherein the body further has fifth and sixth surfaces connected to the first to fourth surfaces and opposing each other in a third direction,
the cross-sectional area of each of the lead-out portions is an area of a cross section of each of the lead-out portions taken at a central portion thereof in the third direction in parallel to the fifth surface of the body, and
the cross-sectional area of each of the sub lead-out portions is an area of a cross section of each of the sub lead-out portions taken at a central portion thereof in the third direction in parallel to the fifth surface of the body.

5. The coil component of claim 1, wherein each of the lead-out portions and the sub lead-out portions has an outer surface contacting the first surface of the body, and an inner surface opposing the outer surface, and
a maximum size in the first direction from the first surface of the body to the inner surface of each of the sub lead-out portions is smaller than a minimum size in the first direction from the first surface of the body to the inner surface of each of the lead-out portions.

6. The coil component of claim 5, wherein a ratio of the maximum size in the first direction from the first surface of the body to the inner surface of each of the sub lead-out portions to the minimum size in the first direction from the first surface of the body to the inner surface of each of the lead-out portions is more than 0.5 and less than 1.

7. The coil component of claim 5, wherein the inner surface of each of the lead-out portions includes a curved surface.

8. The coil component of claim 1, wherein each of the lead-out portions has a cross-sectional area that decreases in an inward direction of the body from the third or fourth surface of the body, based on a cross section thereof perpendicular to the second direction.

9. The coil component of claim 1, wherein each of the sub lead-out portions has a cross-sectional area that is substantially constant in the second direction, based on a cross section thereof perpendicular to the second direction.

10. The coil component of claim 1, wherein a cross-sectional area of each of the lead-out portions included in the first surface of the body is substantially the same as a cross-sectional area of each of the sub lead-out portions included in the first surface of the body.

11. The coil component of claim 1, wherein each of the lead-out portions includes an anchor portion protruding toward the body.

12. The coil component of claim 11, wherein the anchor portion is disposed closer to the second surface of the body than a region other than the anchor portion of each of the lead-out portions.

13. The coil component of claim 1, wherein the coil unit further includes sub vias penetrating through the substrate to connect the lead-out portions and the sub lead-out portions to each other.

14. The coil component of claim 13, wherein each of the sub vias is at least partially contacting the first surface of the body.

15. The coil component of claim 14, wherein each of the sub vias has a semicircular shape.

16. The coil component of claim 1, wherein the coil unit includes first and second coil patterns disposed on opposite surfaces of the substrate, respectively, and further includes a via penetrating through the substrate to connect the first and second coil patterns to each other.

17. A coil component comprising:
a body having first and second surfaces opposing each other in a first direction, and third and fourth surfaces connecting the first and second surfaces to each other and opposing each other in a second direction;
a substrate disposed in the body;
a coil unit disposed on the substrate, and including a coil pattern, lead-out portions connected to the coil pattern and extending to the first surface of the body, and sub lead-out portions spaced apart from the coil pattern, the lead-out portions and the sub lead-out portions opposing each other, respectively, with respect to the substrate; and
external electrodes disposed on the first surface of the body and connected to the lead-out portions, respectively,
wherein a maximum size of each of the lead-out portions in the second direction is greater than a maximum size of each of the sub lead-out portions in the second direction.

18. The coil component of claim 17, wherein each of the sub lead-out portions occupies a smaller volume within the body than each of the lead-out portions.

19. The coil component of claim 17, wherein each of the lead-out portions a first region and a second region, the second region having a smaller size in the second direction and being closer to the first surface of the body than the first region.

20. The coil component of claim 19, wherein a maximum size of each of the sub lead-out portions in the first direction is smaller than a maximum size of the second region of each of the lead-out portions.
